(19) United States
(12) Patent Application Publication
(10) Pub. No.: US 2024/0037550 A1
(43) Pub. Date: Feb. 1, 2024

(54) INFORMATION ENCODING AND TRANSMISSION TECHNIQUES

(71) Applicant: NCR Corporation, Atlanta, GA (US)

(72) Inventor: Robert Michael Dolezal, Buford, GA (US)

(21) Appl. No.: 17/879,591

(22) Filed: Aug. 2, 2022

Related U.S. Application Data
(63) Continuation-in-part of application No. 17/877,614, filed on Jul. 29, 2022, now abandoned.

(51) Int. Cl. G06Q 20/40; H04L 67/50

(52) U.S. Cl. CPC G06Q 20/401; H04L 67/50

(57) ABSTRACT

A transaction is initiated between a first party and a second party. Transaction data for the transaction is obtained and segmented into a subset provided by the first party and a subset provided by the second party. Each subset is further segmented into portions. Each portion is assigned for transmission to a particular one of the parties. A determination is made as to whether each portion is to be encoded in a data structure, a sequence of data structures, or not encoded at all and an optimal channel of communication or multiple channels of communication are selected for transmitting the corresponding portion directly to the corresponding party. At least a portion of the transaction data is provided to a cloud-based transaction service that completes the transaction on behalf of the parties.

### RELATED APPLICATIONS

This application claims priority to and is a continuation in-part of application Ser. No. 17/877,614, entitled “Information Encoding and Transmission Techniques,” filed on Jul. 29, 2022, the disclosure of which is incorporated in its entirety herein.

### BACKGROUND

Data encodings are commonplace in the industry. Encoding data is a convenient way to quickly and efficiently provide a variety of information with some degree of security. For example, barcodes are used to encode a product's identifier and relevant product data. Quick Response (QR) codes are used to encode more information than is available with barcodes, such as information on a company, company contact data, rules for a contest, the company's website, etc. The data structures and encoding techniques of barcodes and QR codes, however, are restricted in an amount of information that can be encoded.

Specifically, linear barcodes are restricted in one dimension with their encodings, while QR codes are restricted in two dimensions. The resolution of a displayed or printed barcode/QR code can also determine the amount of information that can be encoded. Additionally, the compression used in the encodings of the barcodes/QR codes can determine the amount of information that can be encoded as well. Thus, although barcodes and QR codes are now pervasively in the industry, network transactions associated with more voluminous amounts of information have to use encoding and compression techniques other than barcodes/QR codes. As such, existing hardware and software of existing devices that are configured to perform standard operations to encode, decode, and transmit information associated with barcodes and QR codes cannot be employed in scenarios in which barcodes/QR codes are not able to encode the amount of information.

Once information is encoded, the encoded information is often transferred via a network connection; for example, via a wired connection, a wireless connection, or a combination of wired and wireless connections. The information is then exposed to eavesdroppers who can monitor the connections for purposes of stealing the information.

By and large, wireless network connections and transmissions are performed using cellular, short-range, and/or long-range radio frequency (RF) signals through cellular networks, Wi-Fi, Bluetooth®, Bluetooth® low energy (BLE), etc. Rarely are security and efficiency factors considered when two parties are transmitting data to one another. More typically, the parties utilize whatever is available to their devices such as cellular, local-area network (LAN), wide-area network (WAN), Bluetooth®, etc. BLE is often reserved to transfer very small amounts of data between two devices in close proximity to one another.

Thus, if a party wants to transfer a significantly larger amount of information to another party, current encoding techniques cannot be used in their present forms since the amount of information these data structures can encode is limited, which means a non-standard or ad hoc encoding or compression technique has to be employed. Once the information is encoded, no consideration is given to security or efficiency in selecting an optimal transmission medium to provide the encoded information. This means that unnecessary network bandwidth may be wasted, and security associated with the transmission may be compromised allowing the information to be stolen.

### SUMMARY

In various embodiments, methods and a system for providing information encodings and transmission techniques are presented. Transaction data for a transaction is segmented into a subset provided by a first party and a subset provided by a second party. Each subset is further segmented into portions. Each portion is designated for a particular one of the parties. A determination is made as to whether each portion is to be encoded in a data structure, a sequence of data structures, or not encoded at all, and an optimal channel of communication is selected for providing the corresponding portion to the corresponding party. At least a portion of the transaction data is provided to a cloud-based transaction service that completes the transaction on behalf of the parties.

According to an aspect, a method of providing information encodings and transmission techniques is presented. Selections for a first portion of a subset of transaction data associated with a pending transaction are identified based on a sending party. The portion for transmission is assigned to a receiving party. A determination is made as to a transmission channel for delivering the first portion to the receiving party and causing the first portion to be sent over the transmission channel to the receiving party.

### BRIEF DESCRIPTION OF THE DRAWINGS

FIG. 1A is a diagram of encoded information presented through a sequence of codes, according to an example embodiment.

FIG. 1B is a diagram of a system for providing information encodings and transmission techniques, according to an example embodiment.

FIG. 2A is a flow diagram of a method of providing information encodings and transmission techniques, according to an example embodiment.

FIG. 2B is a flow diagram of a particular implementation of the method of FIG. 2A.

FIG. 2C is a flow diagram of another implementation of the method of FIG. 2A.

FIG. 2D is a flow diagram of yet another implementation of the method of FIG. 2A.

FIG. 3A is a flow diagram of another method of providing information encodings and transmission techniques, according to an example embodiment.

FIG. 3B is a flow diagram of a particular implementation of the method of FIG. 3A.

### DETAILED DESCRIPTION

When two or more parties perform a transaction with one another, information has to be exchanged either between the parties or with a third-party service over a network transmission. The manner in which the information is encoded, and the type of network transmission used are of import as these factors impact security of the information and efficiencies of the network transmission.

Embodiments of the disclosed technology presented herein permit information to be encoded using an enhanced set of encoding techniques such that existing hardware and enhanced software may be used to encode, capture, transfer, and decode the information. Using a selected transmission medium, the encoded information can be transferred to a party based on a variety of factors relating to network efficiencies and security concerns.

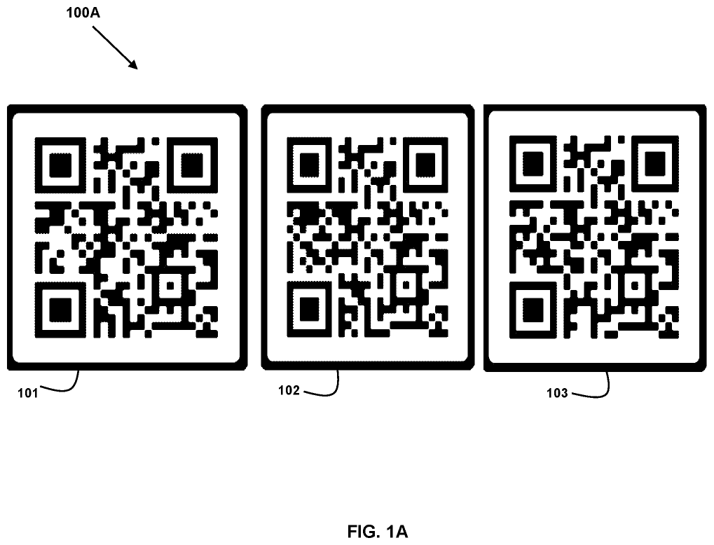

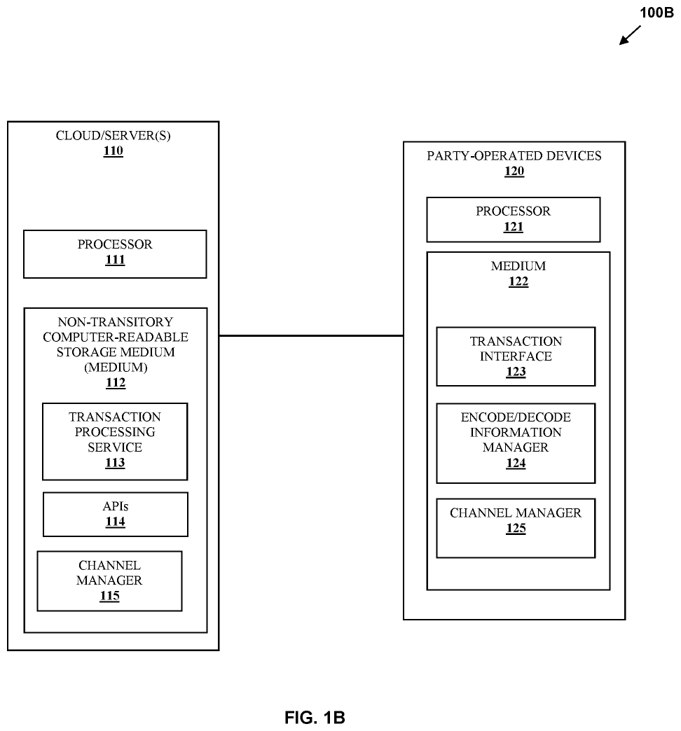

FIG. 1A is a diagram of a data structure 100A of that includes a time sequence of presented codes 101, 102, and 103 that encode information, in accordance with example embodiments. The data structure 100A represents an enhancement over a conventional encoding data structure because the enhanced data structure 100A is capable of handling more voluminous data transfers between parties than a conventional encoding data structure can handle. In example embodiments, the data structure 100A includes a sequence identifier or other linking information that links the codes 101, 102, 103 to the same sequence. In this manner, according to example embodiments of the disclosed technology, the entirety of a voluminous data transfer can be handled by segmenting the data, encoding each segment into a corresponding code capable of being captured and decoded by existing hardware, and linking the codes to a same sequence.

QR codes or other data structures for encoding information are limited in the amount of data they can encode. By sequentially encoding data across multiple codes 101, 102, 103 (e.g., QR codes) and linking sequencing identifiers of the codes, the captured codes can be decoded and assembled in a correct time sequence such that nearly an unlimited amount of information can be encoded using the enhanced data structure 100A.

According to example embodiments of the disclosed technology, existing devices that are able to generate, capture, and decode barcodes and QR codes can be configured to execute an enhanced code-generation application that generates a collection of codes that cumulatively encode data, where each code includes a linking or sequence identifier that links the codes together in a defined sequence, which can then be displayed in sequence (sequenced by time or sequence number) or in a loop on the device that generated the codes.

Similarly, according to example embodiments of the disclosed technology, the capturing device may include an enhanced application that captures each of the individual codes (e.g., QR codes 101, 102, and 103), decodes each code, and identifies the corresponding linking or sequence identifier in each code. The blocks of information are then assembled in a correct order based on each block's sequence identifier. For instance, when QR code 101 is decoded a sequence number of 1 may be identified, when QR code 102 is decoded a sequence number of 2 may be identified, and when QR code 103 is decoded a sequence number of 3 may be identified, thereby indicating the order of the corresponding information encoded in the QR codes.

In an embodiment, a single captured image may include multiple QR codes or an array or grid of QR codes. The resulting image can then individually decode each of the separate QR codes within the single image.

It is to be noted that embodiments presented herein are not restricted to QR codes. Barcodes may be used as well, for example.

Furthermore, in some embodiments, the information encoded in adjacent codes may overlap, such that some information appearing in a next code also appeared in a preceding code. For example, in some embodiment, the graphical content that encodes the information along one dimension may be shifted from frame to frame (e.g., image to image of a sequence of codes) to introduce intentional redundancy in the encoded information. This redundancy in information from code to code yields a number of technical effects including a reduction in the noise associated with the pixel resolutions of images for the codes, improved scanning accuracy, and higher frame rates for displaying images of the codes. For example, shifting a bar code or a QR code a certain number of pixels left or right in each successive frame (e.g., unique code) effectively extends the encoding format to include codes of arbitrary width, increasing the potential information content to a degree limited only by the amount of time available for scanning the complete sequence of codes. Moreover, in example embodiments, existing hardware scanning equipment is enhanced, beyond its typical capturing and decoding capabilities, to include firmware/software modifications that enable reordering of the frames if they are scanned out of order, as long as the displaying equipment cycles through all of the frames during the scanning interval.

Because certain characters or graphical components of a given code can be susceptible to decoding errors, these characters can be uniquely identified in the encoding to permit the decoding application to account for the errors. For example, a color of a component may depend on temperature such that when at a first temperature the color differs slightly from when the component is presented at a different temperature. The decoding application can then make adjustments to properly decode the components based on the current temperature.

The same can be true for viewing-angle-dependent codes to assist the decoding application in orienting the decoded information in a certain direction. For example, in a manufacturing environment, parts may include codes where the temperature in that environment alters a color of a given graphical component. In such scenarios, the scanning robotics can determine the temperature based on the color of the component and adjust operations accordingly. The same can be true in lab or nursery environments.

In an embodiment, the encoding for a given code is changed over time so as to shift the different graphical components into different locations of the imaging sensor. Shifting parts of the code to different positions in the field-of-view over time can help improve reading or capturing of the code by avoiding noise contributors such as glare (e.g., at a certain time of the day or based on the sun and/or other light sources), occlusion (e.g., shadows on the display on which the code is presented), or defective pixels (e.g., in a display location at which the code is presented or received).

Once the information is encoded within a sequence of non-overlapping or overlapping codes, parties to a transaction and/or their device decide as to how the encoded information will be transferred and to whom the encoded information will be transferred. The encoded information may be transferred from one party to the other party, from one party to a cloud transaction processing service, or from both parties to the cloud transaction processing service.

FIG. 1B is a diagram of a system 100B for information encoding and transmission techniques that provides the workflows of FIG. 1A, according to an example embodiment. It is to be noted that the components are shown schematically in greatly simplified form, with only those components relevant to understanding of the embodiments being illustrated.

Furthermore, the various components (that are identified in the FIG. 1B) are illustrated and the arrangement of the components is presented for purposes of illustration only. It is to be noted that other arrangements with more or fewer components are possible without departing from the teachings of providing information encodings and transmission techniques, presented herein and below.

System 100B provides techniques by which parties to a transaction can transmit transaction data using data encoding of their transaction data and efficient transmission mediums. Some of the transmission media are non-conventional. Selection of the transmission medium or channel can be decided based on a variety of factors such as availability and accessibility of the transmission channels, hardware and software available to the parties, channel bandwidth and amount of transaction data that is to be transmitted, whether multiple channels are available depending upon the security associated with the transaction of the transaction data, the parties involved in the transaction (for example, a payer, a payee, and one or more cloud services), and/or what type of transaction data is being shared (for example, itemized receipt, invoice, authorization of payment, etc.).

As used herein, a “transaction” is a set of actions or a workflow that performs access on one or resources to obtain or to update data values (information) associated with the resources. A “resource” is a data asset associated with a given party to the transaction and represented in a data model or a data structure. For example, a resource may be a financial account, social media account, or other service-based account. Access to the resource can be to obtain data values (with no changes) or to update data values associated with one or more fields of one or more resources. For example, a financial service performs a financial transaction on behalf of a payer to pay a payee in a financial transaction. The financial service accesses the financial account (financial resource) of the payer to transfer funds to a financial account (financial resource) of the payee.

“Transaction data” can include a variety of information such as, but not limited to, transaction identifiers, party identifiers, terminal or device identifiers, store identifiers, resource or account identifiers, location information, calendar date, time of day, enterprise identifiers, contact data of the parties, itemized receipts, invoice details, usage instructions, warranty documents, rebate instructions, return policies, resource identifiers, dosage instructions for pharmaceuticals, warnings for products, product nutritional information, advertisements, coupons or promotions, transaction amount due, payment authorizations, and the like. A cloud-based service that performs the transaction using a transaction workflow may require only a subset of the available transaction data for a transaction, such as party identifiers, enterprise identifiers, transaction identifier, calendar date, time of day, transaction amount due, resource identifiers, and payment authorization(s). Other subsets of the transaction data not required by the cloud-based service may be transmitted just between the parties and/or transmitted to the cloud-based service and held on behalf of the parties by the cloud-based service.

Referring to FIG. 1B, system 100B includes a cloud 110 or a server 100 and a plurality of party-operated devices 120. Cloud 110 includes a processor 111 and a non-transitory computer-readable storage medium 112, which includes instructions for a transaction processing service 113, Application Programming Interfaces (APIs) 114, and, optionally, a channel manager 115. When the instructions are provided to or obtained by processor 111, this causes processor 111 to perform operations discussed herein and below for 113-115. Each party-operated device 120 includes a processor 121 and a non-transitory computer-readable storage medium 122, which includes instructions for a transaction interface 123, an encode/decode information manager 124, and a channel manager 125. When the instructions are provided to or obtained by processor 121, this causes processor 121 to perform operations discussed herein and below for 123-124.

Initially two parties engage in a transaction and transaction data is generated or identified. This engagement can be an online engagement or an in-person engagement. The seller (payee) may engage in the transaction via a payee's agent who is operating a terminal 120, via an online service that is processed on website by a server 120 of the payee, and/or via a payee's agent operating a mobile device 120. The buyer (payer) may engage in the transaction by operating a self-service terminal (SST) 120 at a store location of the payee and/or by operating a desktop computer 120 or a mobile device 120 operated by the payee and interacting with a payee's terminal 120, a payee's agent mobile device, and/or a payee's server 120.

Conventionally, to complete a transaction between a payer and a payee, a device 120 of the payer generates a first subset of transaction data for the transaction as an invoice and amount due. The payer provides a payment card to an agent of the payee, to a card reader of a payee's terminal 120, or to a form in a website of a server 120 controlled by the payee for purposes of providing a payer's subset or a second subset of transaction data for the transaction. The payee's applications then obtain selective portions of the first and second subsets of transaction data and interacts with a payment service to request payment for the amount due. When a notification is received from the payment service that the payer's payment was received, the transaction concludes.

System 100B changes this conventional workflow such that payer may or may not provide the payer's subset of transaction data to the payee to complete the transaction. When the payer's subset of transaction data is provided to the payee it is transmitted from a device 120 of the payer to a device 120 of the payee in an encoded format and a disbursements-only account identifier is provided rather than a private account identifier. Transaction processing service 113 manages a disbursements-only account identifier with specific preconfigured conditions set by the payer, such as a limited amount of disbursement, a limited frequency with which disbursements are permitted, etc. When the payer's subset of transaction data is not provided to the payee, the payer may submit the payer's subset of transaction data and the payee's subset of transaction data to transaction processing service 113, in which case the payer receives the payee's subset of transaction data in an encoded format that is transmitted from a device 120 of the payee to a device 120 of the payer. The payee supplies in the payee's subset of transaction data a receipts-only account identifier, on which transaction service enforces conditions to prohibit disbursements from the account associated with the receipts-only account identifier. It may also be that the parties separately submit their subsets of transaction data separately to transaction processing service 113; here, both subsets of transaction data include a same transaction identifier of a same transaction token that permits transaction processing service 113 to link and combine the subsets of transaction data into the transaction data for the transaction.

Furthermore, unlike conventional transactions which rely on the payee for payment authorization, transaction processing service 113 presents an invoice through transaction interface 123 on a payee-operated device 120 to receive the payment authorization for any given transaction. This prevents a payee from intentionally or inadvertently requesting a payment amount that exceeds with transaction payment amount for the transaction because the transaction processing service 113 receives an explicit payment authorization from the payer after providing the payer the invoice and the transaction amount due.

Portions of any encoded subsets of transaction data transferred between devices 120 of the parties may be natively encrypted or non-encrypted (e.g., plain text). For example, the transaction data may include contact data of the payer for purposes of allowing transaction processing service 113 to notify the payer when a transaction payment has been processed for the transaction. The encoded portion of the payer's subset of transaction data for the contact data may be encrypted such that when the subset of transaction data is decoded only encrypted data is available for the contact data of the payer. So, the payer and the transaction processing service may be capable of decrypting the contact data, but the payee is unable to decrypt the contact data. Similarly, portions of the payee's subset of transaction data may be natively encrypted such that after decoding the subset of transaction data those portions remain in an encrypted format and just the payee and the transaction processing service 113 are capable of decrypting those portions.

During engagement for a transaction, the payee and payer interact with their respective transaction interfaces 123 on their devices 120. Interface screens are presented that allow each party to identify the type of transaction, the parties, and their subsets of transaction data. Options within the screen may designate that portions of the subsets of transaction data are to be provided to a party while other portions of the subsets of transaction data are to be provided to the transaction processing service 113.

The channel manager 125 of the devices 120 of the parties then organizes each party's subset of data and identifies which portions of each subset are to be transmitted to which party. The channel manager 125 then determines based on the party whether the each of the portions require encryption or no encryption, this can be determined based on a profile associated with the corresponding party maintained by the transaction interface. Any portion of a party's subset of data requiring encryption is then encrypted using the required keys, which may also be accessible to the channel manager 125 from the profile.

Once both parties have assembled their subsets of transaction data, parties have identified what are to be transmitted portions of the subsets of data, and any portions requiring encryption have been encrypted, the corresponding channel manager 125 interacts with encode/decode information manager 124 for purposes of encoding selective portions of the subset of data that are going to be transmitted via displaying of a sequence of codes for capturing by a device associated with a designated receiving party. In an embodiment, only a portion of the subset of data may be transmitted via playing a sequence of codes on the sending party's display of their device 120. In an embodiment, the entire subset of data for a sending party is transmitted via playing a sequence of codes on the sending party's display of their device 120.

Any portion or a whole subset of transaction data provided by channel manager 125 for encoding is evaluated by encode/decode information manager 124 to determine its size and quality requirements such as noise or error reduction with redundancy of data between codes. Encode/Decode information manager 124 encodes the data producing a sequence of codes, the sequence may have overlapping or repeating data from frame to frame or from code to code or may have no overlapping and unique data within each frame or code. The codes generated are linked or assigned sequence identifiers and provided transaction interface 123 for playing, similar to a video clip, on a display of the sending party's device 120.

Any remaining subset of transaction data not provided via the sequence of codes, is then sent via channel manager to the corresponding parties based on a variety of factors such as availability and accessibility of the transmission channels, hardware and software available to the parties, channel bandwidth and amount of transaction data that is to be transmitted, whether multiple channels are available depending upon the security associated with the transaction of the transaction data, the parties involved in the transaction (for example, a payer, a payee, and one or more cloud services), and/or what type of transaction data is being shared (for example, itemized receipt, invoice, authorization of payment, etc.). The channels available for selection may include cloud-assisted channels and local channels. The local channel may include short-range RF, such as Bluetooth®, local Wi-Fi; modulation of an electromagnetic field in close proximity to a sensor/receiver of the receiving party's device 120; one-dimensional, such as a barcode, or two-dimensional, such as a QR code, optical communication via the sequence of codes discussed above with encode/decode information manager 124; modulation of a low-power laser beam, light emitting diodes (LEDs), or other light source to communicate the data to an optical receiver; air pressure waves, in subsonic, low bandwidth, audible, and/or hypersonic bands with appropriate error detection and correction; Optical Character Recognition (OCR); and multi-channel or multi-spectral communication channels using both the cloud-assisted channel and one or more local channels.

Multi-channel and multi-spectral transmission offers a number of benefits. For example, the likelihood that a bad actor would be able to substitute another data stream for the one being sent is decreased (e.g., to delude the customer into submitting a payment to a different entity besides the transaction processing service 113). Redundancy in the data being sent through a multi-channel approach can facilitate confirmation of an accurate transmission and reception of the transmission, via comparison of data streams from different channels. The multi-channel approach may also be more efficient. Different data communication techniques have different maximum data rates. An effective approach may be to use a lower-bandwidth communication technique to exchange just enough data, such as transaction identifier, a cell number, or a web page, to allow the recipient to access the rest of the data pertaining to the transaction via a higher-bandwidth communication technique. The lower-bandwidth transmission technique may seem superfluous, but such techniques may provide other advantages such as secure transmission and privacy from eavesdroppers by bystanders not involved in the transaction. Lower-bandwidth transmission also allows devices to negotiate selection of secondary channels, transmission rates, etc., to accommodate the capabilities of the devices.

In an embodiment, a text sequence of images is played to transmit portions of the transaction data between the parties. In this embodiment, the text sequence may include some page identifier or time-based sequence implied such that the images can be ordered. The receiving device 130 captures the images and performs Optical Character Recognition (OCR) to translate the images of text information into a portion of the transaction data in text format. In an embodiment, multi-spectral OCR may be processed on one or more images.

In an embodiment, the codes displayed are static codes, that are displayed on a display of a sending device 120 with a configured delay and then a next static code is displayed until a last code is displayed. This permits the receiving device 120 to capture each code individually rather than from an animation of codes played in a loop. In an embodiment, the static codes with delays are played in a loop and reassembled/reordered by the receiving device 120.

In an embodiment, the codes may not only include sequencing, linking, or ordering information but may also include error correction information. So, from one code to a next displayed code encoded error information may allow for correction of errors or identifications of errors present in the displaying of the codes.

In an embodiment, the codes need not be graphical based such as barcodes or QR codes; other data encodings may be used as well, such as symbols, numbers, strings of characters, etc. So, any encoding approach can be used with the embodiments presented herein.

In an embodiment, devices 120 are specialized hardware devices operated by the parties. Each hardware device may be specialized for transaction processing, transmitting a portion of a party's transaction data, capturing the other party's portion of transaction data, and transmitting transaction data in whole or in part to service 123. For example, a payer's device 120 may encrypt and provide disbursements account information; payee's device 120 may encrypt private deposits-only account information; and both payer's device 120 and payee's device 120 may have data transmission capabilities.

In an embodiment, a multi-spectral code is used, which is a graphical-based code that appears different at different wavelengths. This allows encoding of the codes to increase information content in the multi-spectral codes based on their wavelengths. In an embodiment, when a QR code encoding is used, each encoded graphical element may be represented in different colors so as to permit additional information to be encoded in the different bands of the spectrum.

In an embodiment, the transaction identifier may be provided in a first portion by the payer and a second portion by the payee. The service 113 may combine the two portions to form the transaction identifier. It may also be that the transaction identifiers from each of the parties are different transaction identifiers that are linked together as a single transaction by service 113. In an embodiment, each party has its own transaction identifier format, and a transaction token or other linking information permits the service 113 to link the two identifiers as a single transaction.

In an embodiment, the transaction comprises more than two parties. This is a situation where a bill or a purchase is being split among three or more parties, for example, a restaurant bill for which three individuals each ordered different amounts of food, and each has a different amount due. Any of the above-referenced techniques may be used for each party to transmit their transaction data to another party and/or separately to service 113, where service 113 performs the transaction to ensure the payee (restaurant) is paid. This essentially allows for segmentation of the transaction or bill.

In an embodiment, the transaction data as a whole or in part may be retained by the parties or by service 113. The transaction data may be maintained as a record which is searchable by the parties after the transaction completes. This allows the parties to maintain a searchable transaction history on their own devices 120 and/or through service 123.

In an embodiment, the transaction is related to medical invoicing/billing that includes a list of services/materials provided to a patient. The patient can provide the patient's transaction data to the medical company as medical history data where the medical history data is supplied by a medical history application on device 120 or provided by a specialized device 120 that transmits encrypted medical history data and/or insurance information for the patient to a device 120 associated with the medical company. Additionally, any of the above noted encodings, encryption, and/or transmission techniques may be used to provide the medical history data and/or insurance information.

At least one of the parties or both of the parties transmit a minimal amount of the transaction data over a cloud channel to the transaction processing service 113. This may include local exchanges assisted by channel manager 125 between the parties before or after the transmission. The minimal amount of transaction data may include account identifiers for the parties and transaction amount. Transaction processing service 113 then performs the payment transaction by requesting authorization from the payer via the payer's transaction interface 123 and initiating or moving funds associated with the transaction amount from the payer's account to the payee's account. A notification that the transfer is completed is sent by transaction processing service 113 to the payer's transaction interface 123. Optionally, transaction processing service 113 sends a notification of transaction completion to the payee's transaction interface 123.

In an embodiment, transaction interface 123 is configured to segment a party's subset of transaction data into portions associated with the other parties to the transaction that are to receive the portions based on a type of transaction or based on the parties. So, rather than the parties identifying the portions through the interface screens, the portions are automatically segmented by the transaction interface 123.

In an embodiment, channel manager 125 scans local networks Wi-Fi and Bluetooth® to determine or estimate a current load on those networks to determine the factors associated with the network load and capacity. When these networks have tenants above a threshold and/or have low transmission rates, channel manager 125 weights the available bandwidth factor more heavily to bias the channel selection away from these local channels.

In an embodiment, the channel manager 125 of the payer's device 120 establishes a wireless connection with the channel manager 125 of the payee's device 120 for purposes of exchanging configuration information defining the capabilities of each device 120. The capabilities may include available software and sensors, which the channel managers use to negotiate any local channel transmission of portions of the subsets of transaction data.

In an embodiment, once the data requiring encoding and/or encryption and the portions of the subset of transaction data are designated to be transmitted to a given party using a selected channel, channel manager 125 interacts with transaction interface 125 to provide any needed instructions to the corresponding payer or payee needed for the transmission. For example, a transaction interface screen may instruct the payer to place payer's device in line of sight of the payee's device, touch payer's device to payee's device, etc. As another example, a transaction interface screen may play a sequence of codes on the payer's device while the payee's device activates a camera within the payee's transaction interface screens and requests the payee to center the codes being played within the view finder of the camera of the payee's device.

In an embodiment, the transaction data necessary to complete the transaction which is sent by one or both parties to the transaction processing service 113 is sent over an encrypted network connection. In an embodiment, channel managers 125 for the payer's device 120 and for the payee's device send the results of the factors and device capabilities to a channel manager 115 of cloud 110 and channel manager 115 decides the channels for the portions of data that is to be used for the transmissions. Channel manager 115 then reports backs the channels for the portions to transaction interfaces 123 along with instructions to initiate the transfers.

In an embodiment, a payee's channel manager sends an invoice portion of a transaction from the payee's device 120 directly to the transaction interface 123 of the payer's device 120 using a sequence of codes as described above. The transmission is captured and decoded by the payee's device camera and encode/decode information manager 124 and presented within interface screens of the transaction interface 123 of the payer. When payer approves payment through the interface, the approval is sent to transaction processing service 113 along with a transaction identifier for the transaction. The transaction processing service 113 may receive the account identifiers and the transaction amount due from one or both of the parties separately from receipt of the authorization from the payer.

In an embodiment, the parties are automated applications that processing on devices 120 for purposes of exchanging data and performing operations, such as robotic devices on a manufacturing assembling line. For example, a robot may configure its settings for installing a part based on a temperature detected within a code displayed on a screen or a part.

In an embodiment, the transaction between the parties is for a financial transaction, a social media transaction, a medical record transaction, a contract transaction, or any service-based transaction. In cases where the transaction is a non-financial transaction, the transaction data may include confidential, private, or heath data or information.

In an embodiment, party-operated devices can include self-service terminals (SSTs), point-of-sale (POS) terminals, automated teller machines (ATMs), servers, desktop computers, tablets, wearable processing devices, phones, and devices that are part of the Internet-of-Things (IoT).

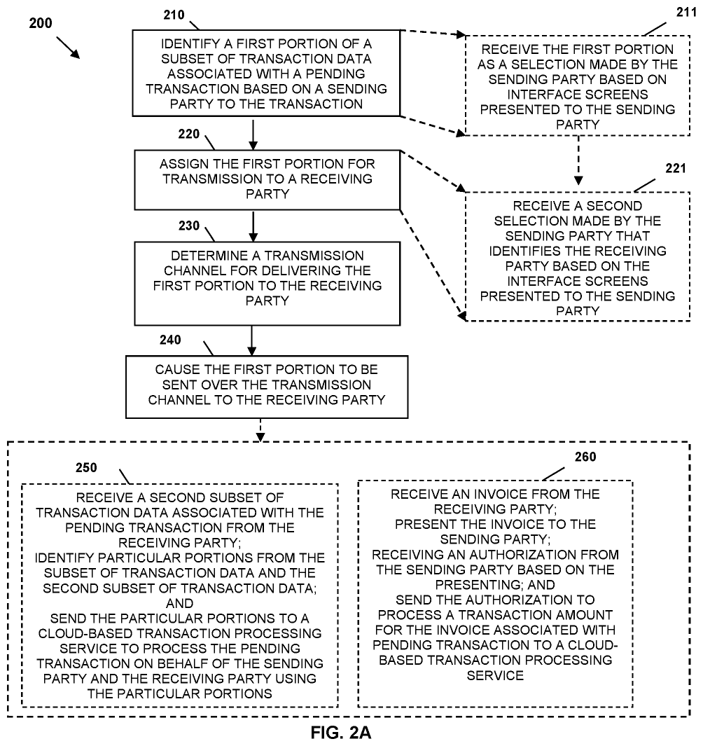

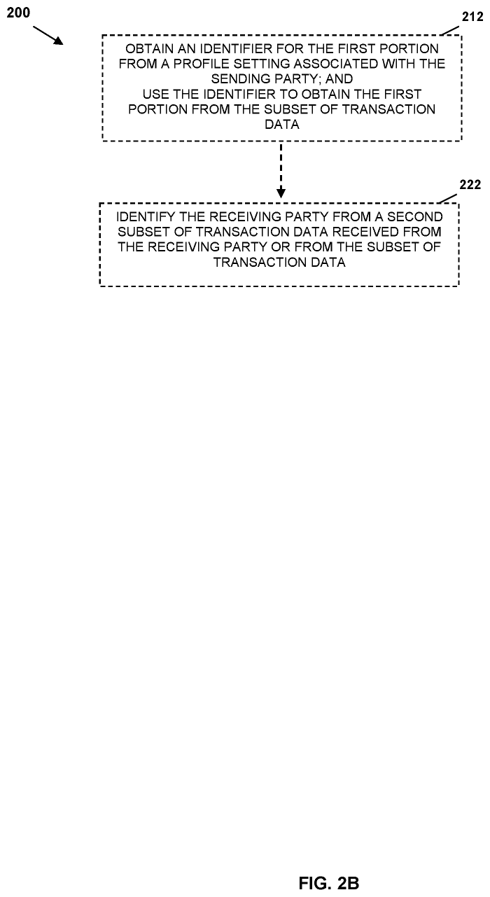

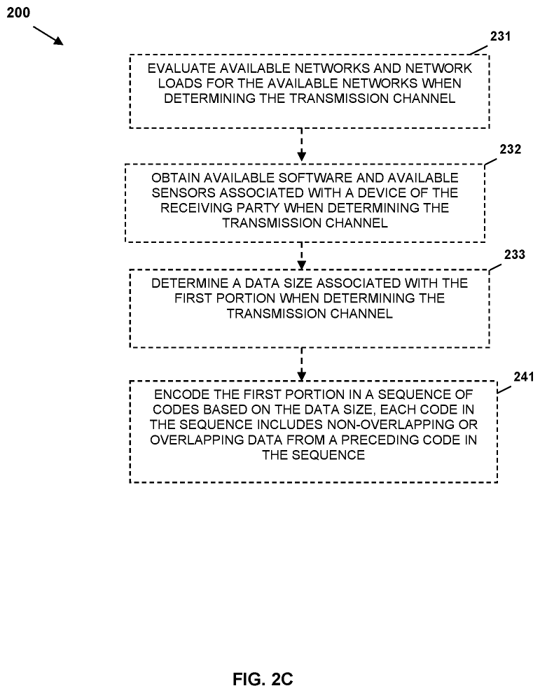

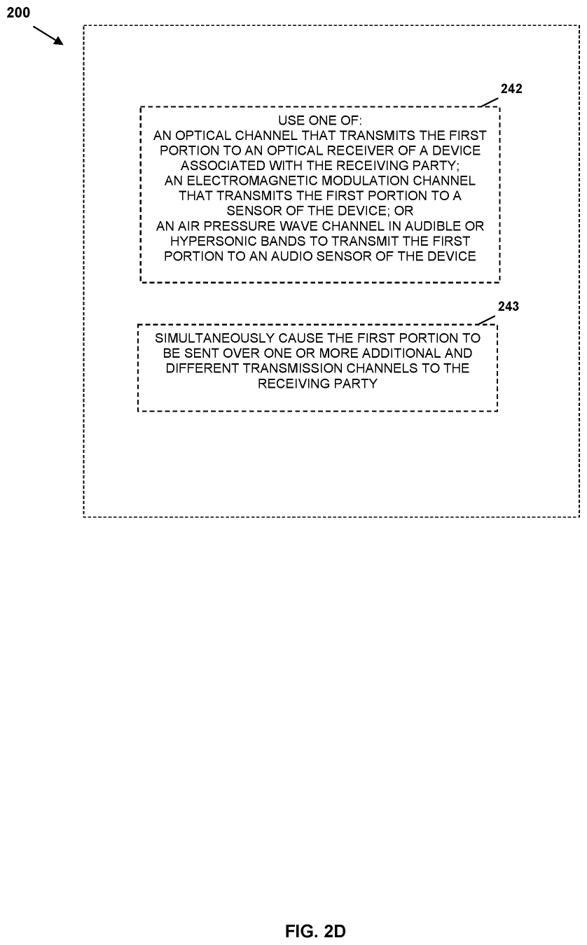

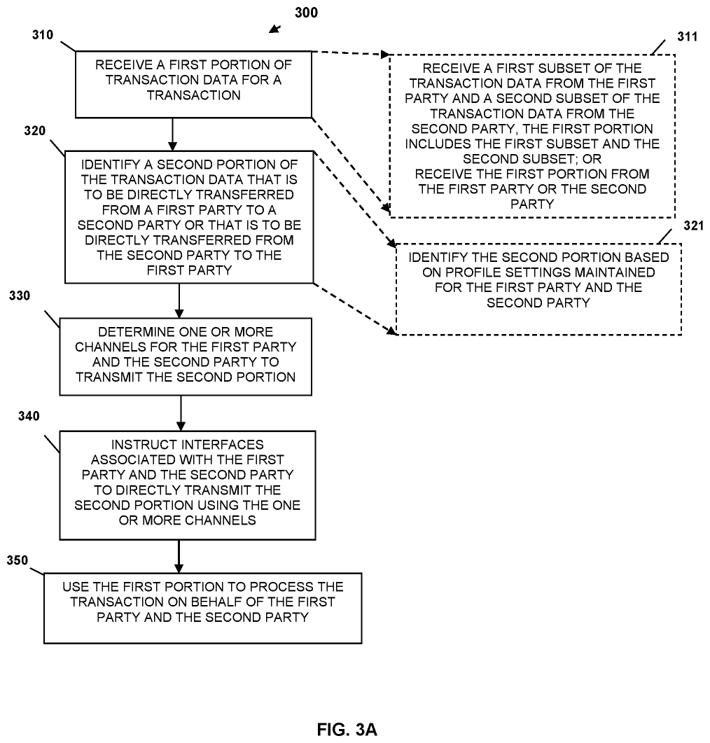

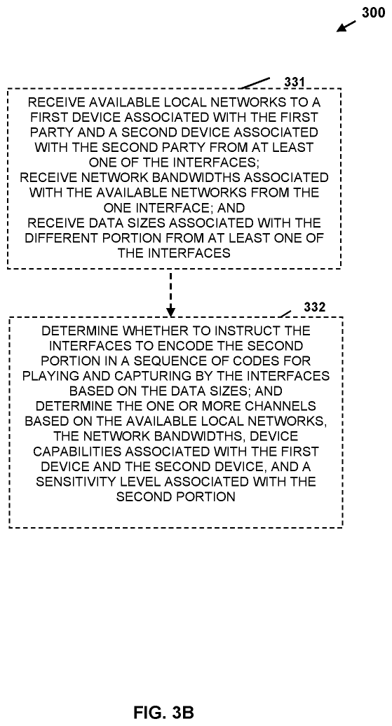

The above-referenced embodiments and other embodiments are now discussed with reference to FIGS. 2A, 2B, 2C, 2D, 3A, and 3B. FIGS. 2A, 2B, 2C, and 2D are diagrams of a method 200 of providing information encodings and transmission techniques, according to an example embodiment. The software module(s) that implements the method 200 is referred to as a “transaction interface.” The transaction interface is implemented as executable instructions programmed and residing within memory and/or a non-transitory computer-readable (processor-readable) storage medium and executed by one or more processors of a device or set of devices. The processor(s) of the device(s) that executes the transaction interface are specifically configured and programmed to process the transaction interface. The transaction interface may have access to one or more network connections during its processing. The network connections can be wired, wireless, or a combination of wired and wireless.

In an embodiment, the transaction interface executes on device 120. In an embodiment, the device 120 is an SST, a POS terminal, an ATM, a server, a desktop computer, a tablet, a wearable processing device, a phone, or an IoT device.

In an embodiment, the transaction interface is one, all, or some combination of 123, 124, and/or 125. In an embodiment, transaction interface presents another, and in some ways, an enhanced processing perspective from that which was discussed above for device 120 of system 100B.

At 210 (shown in FIG. 2A), transaction interface identifies a first portion of a subset of transaction data associated with a pending transaction based on a sending party. The sending party may be a payer, or a payee associated with the pending transaction.

In an embodiment, at 211 (shown in FIG. 2A), the transaction interface receives the first portion as a selection made by the sending party based on interface screens presented on a display of a sender's device 120 to the sending party. That is, transaction interface presents available data for performing the transaction to the second party through the interface screens and the sending party selects the first portion.

In an embodiment, at 212 (shown in FIG. 2B), transaction interface obtains an identifier from a profile setting associated with the sending party. The transaction interface uses the identifier to obtain the first portion from the subset of transaction data associated with the sending party.

At 220 (shown in FIG. 2A), transaction interface assigns the first portion for transmission to a receiving party associated with the pending transaction. Again, the receiving party may be a payer, or a payee associated with the pending transaction.

In an embodiment of 211 and 220, at 221 (shown in FIG. 2A), transaction interface receives a second selection made by the sending party that identifies the receiving party based on the interface screens presented to the sending party. The receiving party explicitly identifies the receiving party of the transaction and indicates through the second selections that the first portion of the subset of transaction data for the sending party is to be directly sent to the receiving party.

In an embodiment of 212 and 220, at 222 (shown in FIG. 2B), transaction interface identifies the receiving party from a second subset of transaction data received from the receiving party or from the subset of transaction data associated with the sending party. That is, an identifier for the receiving party may be entered or scanned by the sending party such that the identifier is linked to the receiving party in the sending party's subset of transaction data. Additionally or alternatively, the receiving party sends a second subset of transaction data to the sending party and the identifier is obtained from the second subset of transaction data.

At 230 (shown in FIG. 2A), transaction interface determines a transmission channel for delivering the first portion directly to the receiving party. It is noted that the transmission channel can be any of the above-referenced channels discussed with the FIG. 1B and system 100B. Moreover, the first portion may be sent redundantly over multiple selected transmission channels.

In an embodiment, at 231 (shown in FIG. 2C), transaction interface evaluates available networks/channels and network/channel loads for the available networks when determining the transmission channel. This can be done by the device 120 that executes the transaction interface performing network scans of its environment to identify the types of wireless networks available and the tenants currently connected to the networks.

In an embodiment, at 232 (shown in FIG. 2C), transaction interface obtains available software and available sensors associated with a device 120 of the receiving party when determining the transmission channel or channels. This can be done through negotiation between the device 120 associated with the sending party and the receiving party to discover the device capabilities of the receiving party's device 120.

In an embodiment, at 233 (shown in FIG. 2C), transaction interface determines a data size associated with the first portion when determining the transmission channel or channels. The data size may dictate whether or not an optical-based channel is capable of being used with encodings as discussed above.

At 240 (shown in FIG. 2A), transaction interface causes the first portion to be sent over the transmission channel or channels to the receiving party. In an embodiment, one transmission channel is used; in an embodiment, the first portion is transmitted in duplicate and simultaneously to the receiving party using multiple separate and different transmission channels.

In an embodiment of 233 and 240, at 241 (shown in FIG. 2C), transaction interface encodes the first portion in a sequence of codes based on the data size and the capabilities of the receiving party's device 120. Each code in the sequence includes non-overlapping data or some overlapping data from a preceding code in the sequence, as was discussed above.

In an embodiment, at 242 (shown in FIG. 2D), transaction interface uses one of: an optical channel that transmits the first portion to an optical receiver of a device 120 associated with the receiving party; an electromagnetic modulation channel that transmits the first portion to a sensor of the device 120; or an air pressure wave channel in audible or hypersonic bands to transmit the first portion to an audio sensor of the device 120. It is noted that the transmission channel may also be RF-based using Wi-Fi, BLE, and/or Bluetooth®.

In an embodiment, at 243 (shown in FIG. 2D), transaction interface simultaneously causes the first portion to be sent over one or more additional and different transmission channels to the receiving party. For example, two or more of the channels discussed in embodiment 241 and 242 may be used to transmit a copy of the first portion to the device 120 of the receiving party.

In an embodiment, at 250 (shown in FIG. 2A), transaction interface receives a second subset of transaction data associated with the pending transaction from the receiving party. The transaction interface identifies particular portions from the subset of transaction data associated with the sending party and from the second subset of transaction data provided by the receiving party. The transaction interface sends the particular portions to a cloud-based transaction processing service 113 to process the pending transaction on behalf of the sending party and the receiving party using the particular portions.

In an embodiment, at 260 (shown in FIG. 2A), transaction interface receives an invoice from the receiving party. The transaction interface presents the invoice to the sending party within interface screens and receives an authorization from the sending party. The transaction interface sends the authorization to process a transaction amount for the invoice associated with the pending transaction to a cloud-based transaction processing service 113 that completes the pending transaction on behalf of the sending party and the receiving party.

FIGS. 3A-3B are diagrams of a method 300 of providing information encodings and transmission techniques, according to an example embodiment. The software module(s) that implements the method 300 is referred to as a “transaction processing service.” The transaction processing service is implemented as executable instructions programmed and residing within memory and/or a non-transitory computer-readable (processor-readable) storage medium and executed by one or more processors of a device or set of devices. The processor(s) of the device that executes the transaction processing service are specifically configured and programmed to process the transaction processing service. The transaction processing service may have access to one or more network connections during its processing. The network connections can be wired, wireless, or a combination of wired and wireless.

In an embodiment, the device that executes transaction processing service is server 110. In an embodiment, the device that executes transaction processing service is a collection of servers logically cooperating as a cloud 110.

In an embodiment, the transaction processing service is all of, or some combination of, 113, 114, and/or 115. The transaction processing service presents another and, in some ways, an enhanced processing perspective from that which was described above for cloud 110 of FIG. 1B. The transaction processing service interacts with method 200.

At 310 (shown in FIG. 3A), transaction processing service receives a first portion of transaction data. In an embodiment, at 311 (shown in FIG. 3A), the transaction processing service receives a first subset of the transaction data from the first party and a second subset of the transaction data independently from the second party; the first portion includes the first subset of the transaction data and the second subset of the transaction data. Alternatively, at 311, the transaction processing service receives the first portion from just the first party or just the second party.

At 320 (shown in FIG. 3A), transaction processing service identifies a second portion of the transaction data that is to be directly transferred from the first party to a second party or that is to be directly transferred from the second party to the first party. It is to be noted that the actual second portion of the transaction data may or may not be in the possession of the transaction processing service; however, the transaction processing service can identify the second portion, for example an invoice.

In an embodiment, at 321 (shown in FIG. 3A), transaction processing service identifies the second portion based on profile settings maintained for the first party and the second party. The profile settings identify the type of transaction data that is assigned to the portion.

At 330 (shown in FIG. 3A), transaction processing service determines one or more channels for the first party and the second party to transmit the second portion. In this case, it is the transaction processing service instead of the devices 120 of the parties that determines the channels that they are to use.

In an embodiment, at 331 (shown in FIG. 3B), transaction processing service receives available local networks to a first device 120 associated with the first party and a second device 120 associated with the second party from at least one of the interfaces 123. The transaction processing service also receives network bandwidths associated with the available networks from the interface 123. Further, the transaction processing service receives data sizes associated with the second portion of transaction data from at least one of the interfaces 123.

In an embodiment of 331 and at 332 (shown in FIG. 3B), transaction processing service determines whether to instruct the interfaces 123 to encode the second portion in a sequence of codes for playing and capturing by the interfaces 123 based on the data sizes. The transaction processing service determines the one or more channels based on the available local networks, the network bandwidths, device capabilities associated with the first device 120 and the second device 120, and a sensitivity level associated with the different portion. The sensitivity level many be a scalar value that identifies the degree of security associated with the second portion, the level of security may restrict the channels selected.

At 340 (shown in FIG. 3A), transaction processing service instructs the interfaces 123 associated with the first party and the second party to directly transmit the second portion to one another using the one or more channels. In an embodiment, the interfaces 123 may send a confirmation back that their data was sent or received, which the transaction processing service may record in an audit log for the transaction.

At 350 (shown in FIG. 3A), transaction processing service uses the first portion obtained at 310 to process the transaction on behalf of the first party and the second party. Again, it is noted that the second portion of the transaction may or may not be available to the transaction processing service. The transaction processing service is at least capable of identifying the type of second portion required by the parties but does not have to physically store and retain the second portion, although the transaction processing service can in some embodiments retain and store the second portion.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner. The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
identifying a first portion of a subset of transaction data associated with a pending transaction based on a sending party to the transaction;
assigning the first portion for transmission to a receiving party;
determining a transmission channel for delivering the first portion to the receiving party; and
causing the first portion to be provided over the transmission channel to the receiving party.

2. The method of claim 1 further comprising:
receiving a second subset of transaction data associated with the pending transaction from the receiving party;
identifying particular portions from the subset of transaction data and the second subset of transaction data; and
sending the particular portions to a cloud-based transaction processing service to process the pending transaction on behalf of the sending party and the receiving party using the particular portions.

3. The method of claim 1 further comprising:
receiving an invoice from the receiving party;
receiving an authorization from the sending party based on the invoice; and
sending the authorization to process a transaction amount for the invoice associated with the pending transaction to a cloud-based transaction processing service.

4. The method of claim 1, wherein identifying further includes receiving the first portion as a selection made by the sending party based on interface screens, auditory channels, or tactile channels presented to the sending party.

5. The method of claim 4, wherein assigning further includes receiving a second selection made by the sending party that identifies the receiving party based on the interface screens, the auditory channels, or the tactile channels presented to the sending party.

6. The method of claim 1, wherein identifying further includes obtaining an identifier for the first portion from a profile setting associated with the sending party and using the identifier to obtain the first portion from the subset of transaction data.

7. The method of claim 6, wherein assigning further includes identifying the receiving party from a second subset of transaction data received from the receiving party or from the subset of transaction data.

8. The method of claim 1, wherein determining further includes evaluating available networks and network loads for the available networks when determining the transmission channel.

9. The method of claim 8, wherein evaluating further includes obtaining available software and available sensors associated with a device of the receiving party when determining the transmission channel.

10. The method of claim 9, wherein obtaining the available software further includes determining a data size associated with the first portion when determining the transmission channel.

11. The method of claim 10, wherein determining the data size further includes encoding the first portion in a sequence of codes, wherein the each code in the sequence includes non-overlapping or overlapping data from a preceding code in the sequence.

12. The method of claim 1, wherein causing further includes using one of an optical channel that transmits the first portion to an optical receiver of a device associated with the receiving party, an electromagnetic modulation channel that transmits the first portion to a sensor of the device, or an air pressure wave channel in audible or hypersonic bands to transmit the first portion to an audio sensor of the device.

13. The method of claim 1, wherein causing further includes simultaneously causing the first portion to be sent over one or more additional and different transmission channels to the receiving party.

14. A method, comprising:
receiving a first portion of transaction data for a transaction;
identifying a second portion of the transaction data that is to be directly transferred from a first party to a second party or that is to be directly transferred from the second party to the first party;
determining one or more channels for the first party and the second party to directly transmit the second portion;
instructing interfaces associated with the first party and the second party to directly transmit the second portion using the one or more channels; and
using the first portion to process the transaction on behalf of the first party and the second party.

15. The method of claim 14, wherein receiving further includes one of:
receiving a first subset of the transaction data from the first party and a second subset of the transaction data from the second party, wherein the first portion comprises the first subset of transaction data and the second subset of transaction data; and
receiving the first portion from the first party or the second party.

16. The method of claim 14, wherein identifying further includes identifying the second portion based on profile settings associated with the first party or the second party.

17. The method of claim 14, wherein determining further includes:
receiving available local networks to a first device associated with the first party and a second device associated with the second party from at least one of the interfaces;
receiving network bandwidths associated with the available local networks from the at least one of the interfaces; and
receiving data sizes associated with the second portion from the at least one of the interfaces.

18. The method of claim 17 further comprising:
determining whether to instruct the interfaces to encode the second portion in a sequence of codes for playing and capturing by the interfaces based on the data sizes; and
determining the one or more channels based on the available local networks, the network bandwidths, device capabilities associated with first device and the second device; and a sensitivity level associated with the second portion.

19. A system, comprising:
a device comprises at least one processor and a non-transitory computer-readable storage medium;
the non-transitory computer-readable storage medium comprises executable instructions;
the executable instructions when executed by the at least one processor from the non-transitory computer-readable storage medium cause the at least one processor to perform operations comprising:
identifying a portion of a subset of transaction data associated with a transaction based on a sending party to the transaction;
assigning the portion for direct transmission to a receiving party;
determining one or more transmission channels for transmitting the portion to the receiving party; and
causing the portion to be sent over one transmission channel to the receiving party or causing the portion to be sent over multiple transmission channels in duplicate to the receiving party.

20. The system of claim 19, wherein the the executable instructions when executed by the at least one processor from the non-transitory computer-readable storage medium further cause the at least one processor to perform additional operations comprising:
receiving a second subset of data directly from the receiving party;
presenting an invoice associated with the second subset of data to the receiving party within an interface;
receiving an authorization to pay a transaction amount associated with the invoice from the sending party through the interface;
sending the authorization to a cloud-based transaction processing service that performs payment processing for the transaction on behalf of the sending party and the receiving party.
